(19) United States
(12) Patent Application Publication
(10) Pub. No.: US 2025/0131818 A1
(43) Pub. Date: Apr. 24, 2025

(54) METHOD FOR DETECTING A TRAFFIC JUNCTION

(71) Applicant: Robert Bosch GmbH, Stuttgart (DE)

(72) Inventors: Mihai Barbulescu, Cluj-Napoca (RO); Bogdan-Alexandru Kandra, Cluj-Napoca (RO); Cristiana-Mirela Lupu, Cluj-Napoca (RO); Manuel Geffken, Braunschweig (DE); Michael Goerlich, Hildesheim (DE)

(21) Appl. No.: 18/901,014

(22) Filed: Sep. 30, 2024

(30) Foreign Application Priority Data
Oct. 18, 2023 (DE) 10 2023 210 179.3

(51) Int. Cl. G08G 1/01

(52) U.S. Cl. CPC G08G 1/0129; G08G 1/0112

(57) ABSTRACT

A method for detecting a traffic junction. The method includes: receiving position data describing a respective position history of motor vehicles traveling on roads which include the traffic junction and traveling through said traffic junction; ascertaining a respective curvature progression of the position histories; ascertaining a respective derivative, in particular a numerical derivative, of the curvature progressions to obtain a respective change in the curvature progressions over the respective position history; detecting the traffic junction based on the respective ascertained derivatives of the curvature progressions. A device, a computer program, and a machine-readable storage medium are also described.

### CROSS REFERENCE

The present application claims the benefit under 35 U.S.C. § 119 of German Patent Application No. DE 10 2023 210 179.3 filed on Oct. 18, 2023, which is expressly incorporated herein by reference in its entirety.

### FIELD

The present invention relates to a method for detecting a traffic junction, a device, a computer program and a machine-readable storage medium.

### BACKGROUND INFORMATION

U.S. Patent Application Publication No. US 2021/0001877 describes a method for determining lane connectivity at traffic intersections for high-resolution maps.

U.S. Patent Application Publication No. US 2022/0057231 A1 describes a method for detecting map calibration errors.

U.S. Patent Application Publication No. US 2022/0383024 describes a method for detecting and coding a road stack interchange based on image data.

### SUMMARY

An object of the present invention is to provide efficient detection of a traffic junction.

This object may be achieved by the present invention. Advantageous example embodiments of the present invention are disclosed herein.

According to a first aspect of the present invention, a method for detecting a traffic junction is provided. According to an example embodiment of the present invention, the method comprises the following steps:
receiving position data describing a respective position history of motor vehicles traveling on roads which include the traffic junction and traveling through said traffic junction,
ascertaining a respective curvature progression of the position histories,
ascertaining a respective derivative, in particular a numerical derivative, of the curvature progressions to obtain a respective change in the curvature progressions over the respective position history,
detecting the traffic junction based on the respective ascertained derivatives of the curvature progressions.

According to a second aspect of the present invention, a device is provided, which is configured to carry out all steps of the method according to the first aspect of the present invention.

According to a third aspect of the present invention, a computer program is provided, which comprises instructions that, when the computer program is executed by a computer, for example by the device according to the second aspect, cause said computer to carry out a method according to the first aspect of the present invention.

According to a fourth aspect of the present invention, a machine-readable storage medium is provided, on which the computer program according to the third aspect of the present invention is stored.

The present invention is based on and includes the realization that the above object is achieved by using the respective position history of a large number of motor vehicles that travel on roads which include the traffic junction and have traveled through said traffic junction to detect the traffic junction. More specifically, it is provided that a respective curvature progression of the position histories is ascertained. This means that the first derivative of the position history is ascertained. This is followed by ascertaining a derivative of the curvature progression in order to obtain a respective change in the curvature progressions over the respective position history. In other words, in each case the second derivative of the position histories is ascertained. The traffic junction is detected based on the respective ascertained derivatives of the curvature progressions.

The reason for this is that a change in the curvature progression indicates whether a road is bending or is becoming straight again. In other words, this makes it possible to efficiently identify a beginning of a road curve and an end of a road curve. As they travel through a traffic junction in different directions, each of the individual motor vehicles is traveling a curve. This means that multiple curves within a narrowly defined region or area are a strong indication that there is a traffic junction at that location or within that area. The traffic junction can thus be efficiently detected based on the ascertained derivatives of the curvature progressions.

Unlike the above-described related art, the method therefore does not require any image data to detect traffic junctions. It is sufficient to use the respective position histories. The position histories thus describe or characterize the positions of the motor vehicles as they travel on the road(s) and travel through the traffic junction. The position data can also be referred to as trace data. They are referred to as trace data, because these data describe the lanes traveled by the motor vehicles.

A traffic junction within the meaning of the description is a junction in the road traffic. A junction in the road traffic is a physical structure that serves to link roads. This means that a number of roads intersect at a traffic junction and/or one road flows into another road.

A traffic junction is an intersection, a roundabout, a junction, an on-ramp onto a country road, a federal highway or freeway, an off-ramp from a country road, a federal highway or freeway, or a highway interchange, for example.

In one example embodiment of the method of the present invention, it is provided that road curves are detected based on the respectively ascertained derivatives of the curvature progressions, wherein the traffic junction is detected based on the detected road curves.

This, for example, produces the technical advantage that road curves can be efficiently detected based on which the traffic junction can be efficiently detected, which has already been discussed above.

When the term “curve” is used in the description, it should always be understood that this is a road curve, even if this is not explicitly stated.

In one example embodiment of the method of the present invention, it is provided that a number of entrances and exits into or out of the road curve is ascertained for each road curve, wherein the traffic junction is detected based on the ascertained numbers of entrances and exits.

This, for example, produces the technical advantage that the traffic junction can be efficiently detected. This embodiment is based on the realization that there are typically differences in the numbers of entrances and exits of a traffic junction compared to a simple road curve.

In one example embodiment of the method of the present invention, it is provided that a road curve is specified as belonging to a traffic junction if the number of entrances and exits is greater than or equal to three.

This, for example, produces the technical advantage that the traffic junction can be efficiently detected.

This means that, if a road curve is detected, the number of entrances and exits of which is greater than or equal to three, that road curve is specified as being a traffic junction, so that the traffic junction is efficiently detected.

A road curve typically has only one exit and one entrance. This means that it is possible to travel into and out of a road curve. If there is a third way to travel into a detected road curve, however, it has to necessarily be a junction, because another road flows into it or intersects it here.

The number of entrances and exits can therefore be used to efficiently specify whether a detected road curve is a traffic junction or not.

In one example embodiment of the method of the present invention, it is provided that detected road curves that exhibit an abnormal course are filtered out, wherein the traffic junction is detected based on the road curves that have not been filtered out.

This, for example, produces the technical advantage that implausible results are filtered out and therefore no longer used to detect the traffic junction so that the traffic junction can be reliably detected.

A road curve is implausible, for example, if the distance between the entrance and exit is greater than or equal to a predetermined distance threshold value.

In one example embodiment of the method of the present invention, it is provided that a polygon which represents the respective road curve is ascertained for each road curve (that has not been filtered out), wherein the traffic junction is detected based on the ascertained polygons.

This, for example, produces the technical advantage that the road curve can be efficiently represented, so that the traffic junction can be efficiently detected based on this. Representing a road curve with a polygon makes it possible to carry out the corresponding calculations in a particularly efficient manner.

The advantage of describing a road curve with a polygon is in particular that a polygon describes only the spatial extent of the traffic junction and thus makes it independent of the specific relationship with the travel paths that were used for detection. Among other things, this also allows the assignment of other spatially defined structures to the detected traffic junction, such as that of a road (for instance, defined by a line) that passes through such a polygon.

In one example embodiment of the method of the present invention, it is provided that, to respectively ascertain the number of entrances and exits into or out of the road curve, a number of entrances and exits into or out of the respective polygon is ascertained, wherein the traffic junction is detected based on the ascertained numbers of entrances and exits into or out of the respective polygon.

This, for example, produces the technical advantage that the traffic junction can be efficiently detected. The general statements made above in connection with the number of entrances and exits of road curves apply analogously to the number of entrances and exits into or out of a polygon that describes a road curve.

It is therefore, for example, provided that a polygon belongs to a traffic junction if the number of entrances and exits into or out of the polygon is greater than or equal to three.

In one example embodiment of the method according to the first aspect of the present invention, it is provided that a respective measure of dispersion of the values of the respectively ascertained derivatives of the curvature progressions is ascertained, wherein values of the respectively ascertained derivatives of the curvature progressions which exceed the respective measure of dispersion are ascertained, wherein the values which exceed the respective measure of dispersion are respectively grouped in intervals with a positive change of curvature and a negative change of curvature, wherein a road curve is specified as being a pair of immediately successive intervals with a respective positive and negative change of curvature.

This, for example, produces the technical advantage that a curve in the course of the road can be efficiently identified. The reason for this is that, if there is a positive change of curvature, it can be assumed that the road is bending, i.e. curving. If there is a negative change of curvature, it can be assumed that the curved road is straightening out again in terms of its course.

Within the meaning of this description, the road is bending means that the road is curving in terms of its course, i.e., the course of the road is curving. Straightening out or becoming straight means that the curved course of the road is becoming straight again.

In one example embodiment of the method according to the first aspect of the present invention, it is provided that the respective standard deviation of the values of the respectively ascertained derivatives of the curvature progressions is ascertained, wherein the respective measure of dispersion is ascertained based on the respective standard deviation.

This, for example, produces the technical advantage that the respective measure of dispersion can be efficiently ascertained.

The respective measure of dispersion is the standard deviation of the values of the respectively ascertained derivative of the curvature progressions, for example.

In one example embodiment of the method according to the first aspect of the present invention, it is provided that the respective standard deviation is scaled with a predetermined scaling factor, which is not equal to 1, to obtain a respective scaled standard deviation, wherein the respective measure of dispersion is ascertained based on the respectively scaled standard deviation.

This, for example, produces the technical advantage that it makes it possible to adjust the determined standard deviation in order to fine-tune the detection. In a productively used embodiment, however, this can be deactivated and, for instance, a fixedly prescribed threshold value is used.

The measure of dispersion is equal to the scaled standard deviation, for example.

In one example embodiment of the method according to the first aspect of the present invention, it is provided that the points are clustered within a road curve, wherein the corresponding polygon is created such that it includes all of the points of each cluster.

This, for example, produces the technical advantage that the corresponding polygon can be efficiently created.

Clustering advantageously first enables the creation of a defined intersection (generally a traffic junction), because several individual identifications of possible intersections (generally traffic junctions) can be combined based on individual travel paths.

In one example embodiment of the device according to the second aspect of the present invention, it is provided that the device is programmed such that it can carry out the computer program according to the third aspect.

Technical functionalities of the device of the present invention result analogously from corresponding technical functionalities of the method of the present invention and vice versa. Method features thus result analogously from corresponding device features and vice versa.

The method of the present invention is, for instance, carried out by means of the device.

The method of the present invention is a computer-implemented method, for example.

A position within the meaning of the description specifies a latitude and a longitude, for example. The position also specifies an elevation, for instance, in particular an elevation relative to sea level.

The embodiments and embodiment examples of the present invention described here can be combined with one another in any way, even if this is not explicitly described.

The present invention will be explained in more detail with reference to preferred embodiment examples.

### BRIEF DESCRIPTION OF THE DRAWINGS

FIG. 1 shows a flowchart of an example method according to the first aspect of the present invention.

FIG. 2 shows an example device according to the second aspect of the present invention.

FIG. 3 shows an example computer program according to the fourth aspect of the present invention.

FIG. 4 shows a graph showing a curvature progression and a derivative of the curvature progression.

FIG. 5 shows an enlarged detail of the graph according to FIG. 4.

FIGS. 6 and 7 show detected road curves belonging to a traffic junction.

FIGS. 8 and 9 show respectively detected traffic junctions.

FIG. 10 shows a block diagram according to an example embodiment of the present invention.

### DETAILED DESCRIPTION OF EXAMPLE EMBODIMENTS

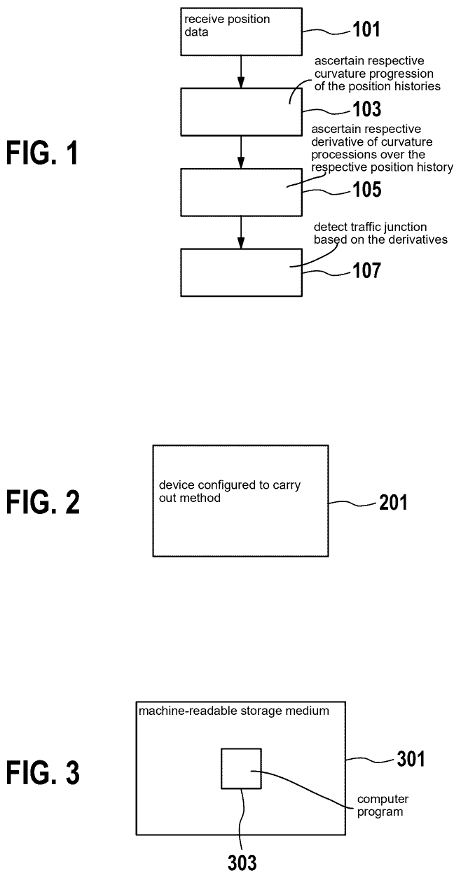

FIG. 1 shows a flowchart of a method for detecting a traffic junction, comprising the following steps:
receiving 101 position data describing a respective position history of motor vehicles traveling on roads which include the traffic junction and traveling through said traffic junction, ascertaining 103 a respective curvature progression of the position histories,
ascertaining 105 a respective derivative, in particular a numerical derivative, of the curvature progressions to obtain a respective change in the curvature progressions over the respective position history,
detecting 107 the traffic junction based on the respective ascertained derivatives of the curvature progressions.

A position of the detected traffic junction is determined for a detected traffic junction, for example.

A detected traffic junction is added to a digital road map, for example.

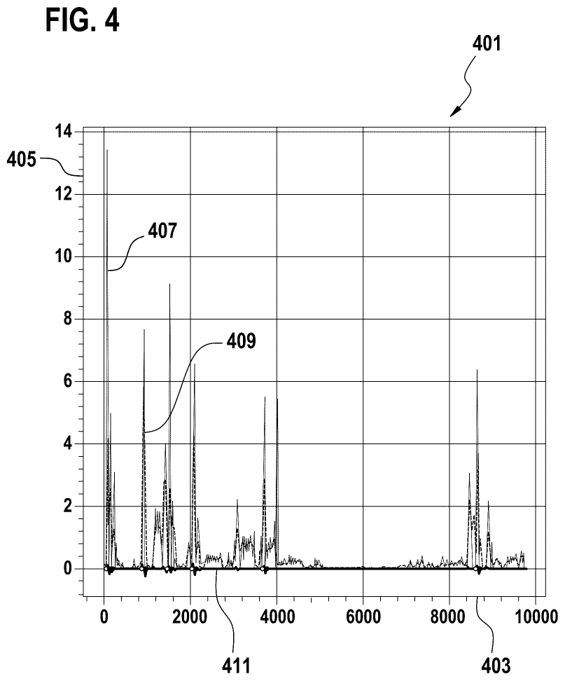

FIG. 2 shows a device 201, which is configured to carry out all steps of the method according to the first aspect.

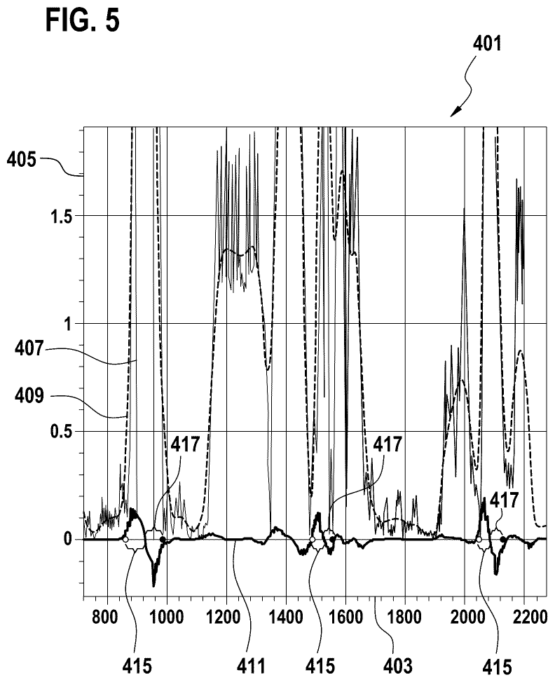

FIG. 3 shows a machine-readable storage medium 301, on which a computer program 303 is stored. The computer program 303 comprises instructions that, when the computer program 303 is executed by a computer, cause the computer to carry out a method according to the first aspect.

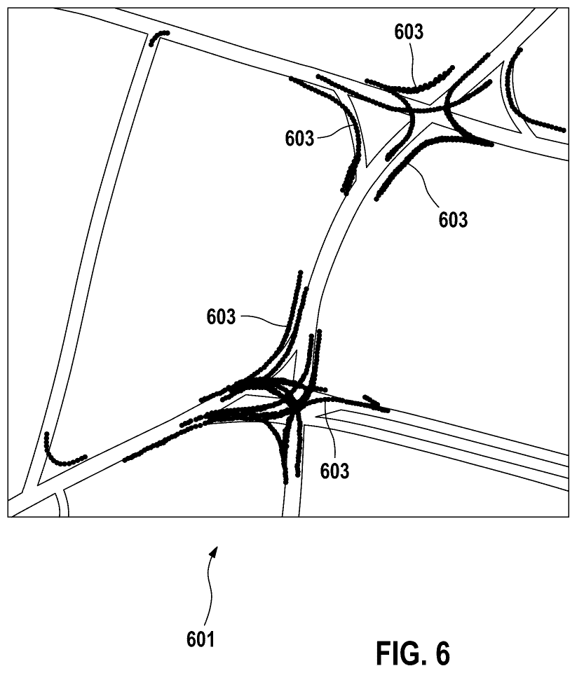

FIG. 4 shows a graph 401 that depicts a curvature progression and a derivative of the curvature progression over a distance, i.e. over a position history.

The distance traveled by the associated motor vehicle is plotted in meters on an abscissa 403 of graph 401. The curvature progression and the derivative of the curvature progression are plotted in arbitrary units on an ordinate 405 of the graph 401.

The distance, i.e. the distance traveled, can be ascertained based on the position data, for example.

The reference sign 407 points to a curvature progression that has additionally been smoothed, wherein the smoothed curvature progression is labeled with the reference sign 409.

The reference sign 411 points to a change in the curvature progression according to the smoothed curvature progression 409.

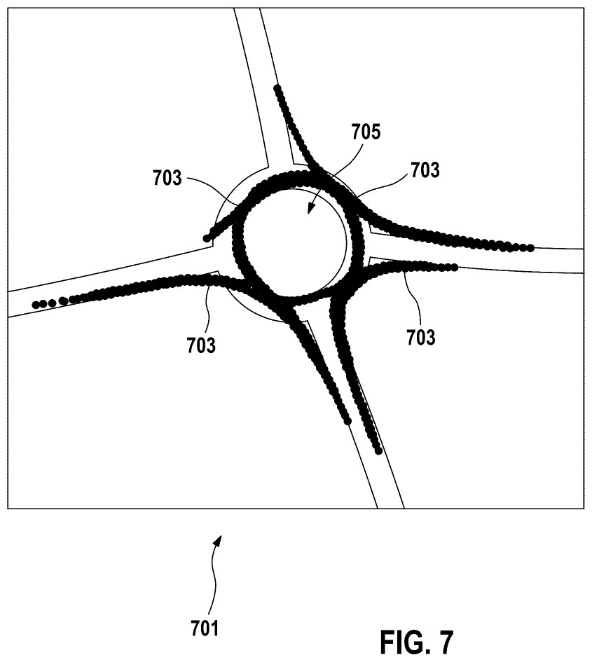

FIG. 5 shows an enlarged view of the graph 401 according to FIG. 4.

The reference sign 415 identifies an interval with values exhibiting a positive change of curvature. The reference sign 417 identifies a second interval exhibiting values with a negative change of curvature. The intervals 415, 417 each form a pair of immediately successive intervals with a respective positive and negative change of curvature, such that the associated road section describes a curve.

At approximately the x-coordinate “1350” it might look as if there also is a pair of immediately successive intervals with a respective positive and negative change of curvature, so that the associated road section describes a curve. A distance between the positive and the negative interval is too large here, however, so that this travel path was excluded as unlikely. The threshold value for “too large” can be an adjustable parameter.

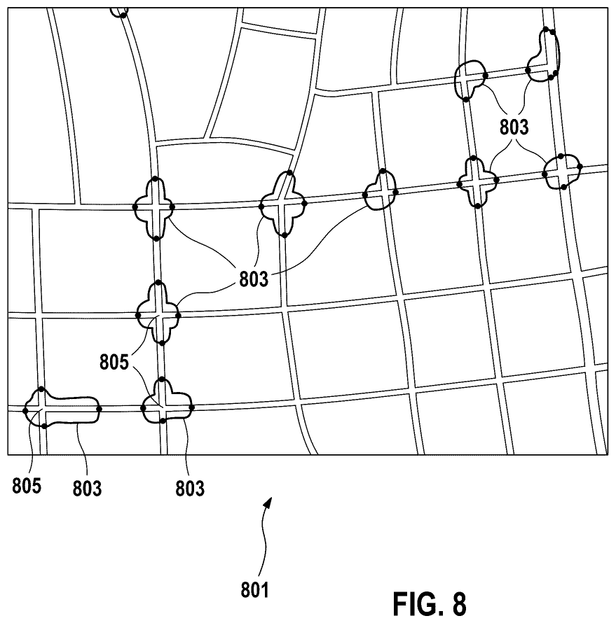

FIG. 6 shows a road map 601 on which detected road curves are superimposed. For the sake of clarity, not all of the road curves shown in FIG. 6 are used with their own reference sign. The reference sign 603 is used for several of them. The detected road curves 603 accordingly belong to a number of traffic junctions, which can be ascertained because a number of exits and entrances to the road curves 603 is greater than or equal to three.

FIG. 7 shows another road map 701 on which a number of detected road curves 703 are superimposed in the same way as in FIG. 6. A roundabout 705, which is clearly represented by the detected road curves 703, is shown as an example. In the present example, a number of entrances and exits to the detected road curves 703 is three, so that the detected road curves 703 can be defined or specified as belonging to a traffic junction, so that a traffic junction, the roundabout 705, is detected here.

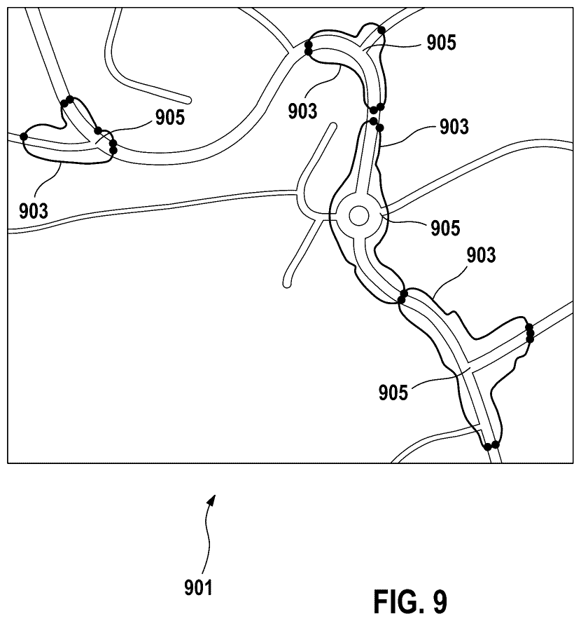

FIG. 8 shows another road map 801. The reference sign 803 identifies regions that can also be referred to as geographic regions within which a traffic junction 805 has been detected according to the concept described here.

FIG. 9 shows another road map 901, in which, in the same way as in FIG. 8, a number of geographic regions 903 for which a traffic junction 905 has been detected according to the concept described here are shown.

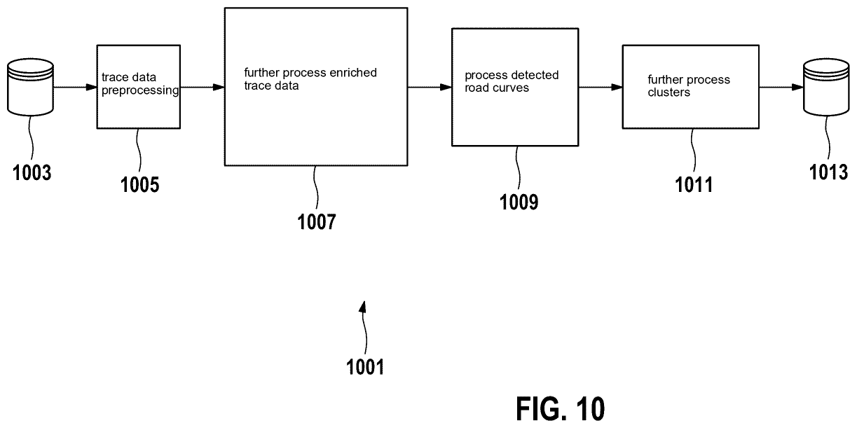

FIG. 10 shows a block diagram 1001 that explains the here-described concept using an example.

A large amount of trace data 1003 is received from a large number of motor vehicles that have traveled on roads that include a traffic junction or also multiple traffic junctions, wherein the motor vehicles have traveled at least partly through the traffic junctions. These trace data 1003 are position data within the meaning of the description.

According to a function block 1005, trace data preprocessing takes place. The trace data 1003 are enriched, for example with data relating to the angle of curvature, i.e. the curvature of the position history. A smoothing of the curvature progression takes place as well. The correspondingly enriched trace data is further processed according to a function block 1007. The derivative of the angle of rotation is calculated for the trace data, for instance. Outlier or deviating values of the change of curvature, for example, are furthermore defined as those values of the change of curvature that, for instance, exceed the standard deviation scaled with a predetermined scaling factor of all data. The deviating values are then grouped in order to detect road curves. The detected road curves are then divided into timeboxes, so that they do not extend over more than a user-defined number of seconds.

Timeboxing is provided to trim the trajectory section that describes the travel through the traffic junction into a most specific as possible section having the greatest curvature. The polygon generated later by clustering and viewing the clusters will consequently be narrower and will describe the traffic junction better.

The detected road curves are further processed according to a function block 1009, wherein the points of the detected road curve are respectively clustered and the clusters are stored.

The clusters are then further processed according to a function block 1011. The numbers of entrances and exits to and from the clusters are ascertained, and the clusters the respective number of which is less than three are filtered out. Abnormal progressions of the clusters are filtered out as well. The remaining, i.e. those that are not filtered out, are the detected traffic junctions 1013.

The concept described here is in particular based on the realization that traffic junctions are geographic regions in which multiple roads intersect or one road flows into another road. The roads that belong to a traffic junction are therefore connected to one another. Road traffic in such areas consequently has a much higher turn rate than outside such an area. Identifying and grouping points of the position histories of motor vehicles traveling through such an area that have high turning angles in the position histories makes it possible to efficiently identify and delimit the traffic junctions.

For example, the method according to the first aspect comprises one or more of the following steps:
1. Preprocessing of the data: The trace data, i.e. the position histories that describe the geographic position (latitude, longitude and optionally the elevation) are enriched with data relating to the angle of rotation, for example. This means that, for each position, the angle of rotation of the position history, which can also be referred to as the angle of curvature, is ascertained, i.e. the first derivative of the position history. The angle of rotation is in particular a discrete approximate value for the curvature of the position history. The value is in particular calculated for each data point, i.e. for each position.

The, in particular numerical, derivative of the angle of rotation, for instance, i.e. the change of curvature, is calculated for the entire data set, i.e. for all positions.

Outlier or deviating values of the change of curvature, for example, are defined as those values of the change of curvature that, for instance, exceed the standard deviation scaled with a predetermined scaling factor of all data. These deviating or outlier values are thus identified within the data or values of the change of curvature.

For each curve, for instance, the outlier values, i.e. the outlier or the deviating values, are grouped, in particular using a distance metric, into, in particular quasi-continuous, intervals with (completely) negative or positive values. The term “quasi-continuously” here means that there can be a limited number of missing values between two outlier values in an interval.

A curve is defined as a pair of intervals with outlier values grouped according to negative and positive change of curvature, for example. A curve is thus defined in particular by a first interval which comprises the grouped outlier values having a positive change of curvature, wherein the first interval indicates that the road is starting to bend, wherein the curve is further defined by a second interval which immediately follows the first interval and comprises the grouped outlier values having a negative change of curvature, wherein the second interval indicates that the road is becoming straight again. The road curve is in particular identified by connecting these two intervals to one another using a distance metric. The turns are then divided into timeboxes, so that they do not extend over more than a user-defined number of seconds.

The points within each road curve are clustered, for instance, in particular using a standard clustering algorithm, for example, by means of DBSCAN (density-based spatial clustering of applications with noise). For example, a polygon that contains all of the points in each cluster is created.

To distinguish road curves from traffic junctions, it is provided that the road curves are filtered out based on the number of entrances and exits to the road curve, for example, in particular in the polygon associated with the road curve. A traffic junction includes three or more than three entrances and exits, whereas a road curve has only one or two entrances and exits.

The concept described here in particular enables an acquisition of knowledge about the location of traffic junctions. The concept described here in particular makes it possible to distinguish between a road and a traffic junction. Based on this knowledge and ability, ADAS systems (ADAS stands for advanced driver assistance systems) can advantageously better navigate road and traffic junction in both scenarios. ADAS systems can benefit from knowledge about the location of traffic junctions and the distinction between road and traffic junctions, because they can use the knowledge of how driver behavior, which is described in particular by the position history and the corresponding derivatives, differs within the boundaries of traffic junctions to adapt their traveling parameters to handle such situations better and more efficiently.

What is claimed is:

1. A method for detecting a traffic junction, comprising the following steps:
receiving position data describing a respective position history of motor vehicles traveling on roads which include the traffic junction and traveling through the traffic junction;
ascertaining a respective curvature progression of each of the position histories,
ascertaining a respective numerical derivative of each of the curvature progressions to obtain a respective change in the curvature progressions over the respective position history; and
detecting the traffic junction based on the respective ascertained derivatives of the curvature progressions.

2. The method according to claim 1, wherein road curves are detected based on the respective ascertained derivatives of the curvature progressions, wherein the traffic junction is detected based on the detected road curves.

3. The method according to claim 2, wherein a number of entrances and exits into or out of the road curve is ascertained for each road curve, wherein the traffic junction is detected based on the ascertained numbers of entrances and exits.

4. The method according to claim 3, wherein a road curve is specified as belonging to a traffic junction when the number of entrances and exits is greater than or equal to three.

5. The method according to claim 2, wherein detected road curves that exhibit an abnormal course are filtered out, wherein the traffic junction is detected based on the road curves that have not been filtered out.

6. The method according to claim 5, wherein a polygon which represents the respective road curve is ascertained for each road curve that has not been filtered out, wherein the traffic junction is detected based on the ascertained polygons.

7. The method according to claim 6, wherein a number of entrances and exits into or out of the road curve is ascertained for each road curve, wherein the traffic junction is detected based on the ascertained numbers of entrances and exits, and wherein, to respectively ascertain the number of entrances and exits into or out of the road curve, a number of entrances and exits into or out of the respective polygon is ascertained, wherein the traffic junction is detected based on the ascertained numbers of entrances and exits into or out of the respective polygon.

8. The method according to claim 2, wherein a respective measure of dispersion of values of the respectively ascertained derivatives of the curvature progressions is ascertained, wherein those of the values of the respectively ascertained derivatives of the curvature progressions which exceed the respective measure of dispersion are ascertained, wherein those of the values which exceed the respective measure of dispersion are respectively grouped in intervals a positive change of curvature and a negative change of curvature, wherein a road curve is specified as being a pair of immediately successive intervals with a respective positive and negative change of curvature.

9. The method according to claim 8, wherein a respective standard deviation of the values of the respectively ascertained derivatives of the curvature progressions is ascertained, wherein the respective measure of dispersion is ascertained based on the respective standard deviation.

10. The method according to claim 9, wherein the respective standard deviation is scaled with a predetermined scaling factor, which is not equal to 1, to obtain a respective scaled standard deviation, wherein the respective measure of dispersion is ascertained based on the respectively scaled standard deviation.

11. The method according to claim 6, wherein values of the position data are clustered within a road curve, wherein the corresponding polygon is created such that it includes all of the values of each cluster.

12. A device configured to detect a traffic junction, the device configured to:
receive position data describing a respective position history of motor vehicles traveling on roads which include the traffic junction and traveling through the traffic junction;
ascertain a respective curvature progression of each of the position histories,
ascertain a respective numerical derivative of each of the curvature progressions to obtain a respective change in the curvature progressions over the respective position history; and
detect the traffic junction based on the respective ascertained derivatives of the curvature progressions.

13. A non-transitory machine-readable storage medium on which is stored a computer program for detecting a traffic junction, the computer program, when executed by a computer, causing the computer to perform the following steps:
receiving position data describing a respective position history of motor vehicles traveling on roads which include the traffic junction and traveling through the traffic junction;
ascertaining a respective curvature progression of each of the position histories,
ascertaining a respective numerical derivative of each of the curvature progressions to obtain a respective change in the curvature progressions over the respective position history; and
detecting the traffic junction based on the respective ascertained derivatives of the curvature progressions.
